(19) United States
(12) Patent Application Publication
(10) Pub. No.: US 2008/0304272 A1
(43) Pub. Date: Dec. 11, 2008

(54) LIGHT BULB SYSTEM

(76) Inventors: Mickael Collins Joasil, Nepean (CA); Thomas Joseph Broeski, Afton, VA (US)

Correspondence Address: MCNEES WALLACE & NURICK LLC, 100 PINE STREET, P.O. BOX 1166, HARRISBURG, PA, 17108-1166, US

(21) Appl. No.: 12/136,926

(22) Filed: Jun. 11, 2008

Related U.S. Application Data
(60) Provisional application No. 60/943,166, filed on Jun. 11, 2007.

(51) Int. Cl. F21S 15/00

(52) U.S. Cl. 362/458

(57) ABSTRACT

A light bulb system is provided. This system includes a lighting element that is adapted to draw electrical power from a standard light bulb socket as a primary power source; and an energy capturing and storing device in electrical communication with the lighting element for providing sufficient electrical power to the lighting element as a secondary power source. The energy capturing and storing device further includes means for capturing and converting non-electrical energy into electrical energy, which may be stored for use in powering the lighting element when the primary source of electrical power is either unavailable or when its use is undesirable.

### CROSS-REFERENCE TO RELATED APPLICATIONS

This patent application claims the benefit of U.S. Provisional Patent Application Ser. No. 60/943,166 filed on Jun. 11, 2007 and entitled “Self-Charging Light Bulb System,” the disclosure of which is incorporated by reference as if fully rewritten herein.

### BACKGROUND OF THE INVENTION

The described invention relates in general to a light bulb system for use in multiple lighting applications, and more specifically to a light bulb system that is configured to draw power from both a primary power source and a secondary or back-up power source which typically includes at least one type of rechargeable power capturing and storing device.

Light bulbs are extremely common devices that are used around the world on a daily basis for providing a source of visible light in a wide variety of locations. Although extremely common, light bulb design and function has not significantly advanced in recent years. More specifically, light bulbs are typically designed to draw power from a single electrical source such as the common light bulb sockets that are found in most buildings. In the event that electrical power is lost, most light bulbs are quickly rendered useless for their intended purpose. In parts of the world where electrical power is inconsistent or intermittent, the common light bulb does not provide adequate lighting means. Therefore, there is a need for a light bulb system that is capable of providing visible light both when electrical power is available and when electrical power has been interrupted.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a lighting system is provided. This system includes a lighting element that is adapted to draw electrical power from a standard light bulb socket as a primary power source; and an energy capturing and storing device in electrical communication with the lighting element for providing sufficient electrical power to the lighting element as a secondary power source. The energy capturing and storing device is initially charged and then recharged with successive uses of the light bulb system by the primary power source.

In accordance with another aspect of the present invention, a light bulb system is provided. This system includes a lighting element that is adapted to draw electrical power from a standard light bulb socket as a primary power source; and an energy capturing and storing device in electrical communication with the lighting element for providing sufficient electrical power to the lighting element as a secondary power source. The energy capturing and storing device further includes means for capturing and converting non-electrical energy into electrical energy, which may be stored for use in powering the lighting element when the primary source of electrical power is either unavailable or when its use is undesirable. In some situations, the source of non-electrical energy is the light bulb itself, thereby making this system essentially “self-charging”.

In yet another aspect of this invention, a rechargeable light bulb system is provided. This system includes a lighting element that is adapted to draw electrical power from a standard light bulb socket as a primary power source; and an energy capturing and storing device in electrical communication with the lighting element for providing sufficient electrical power to the lighting element as a secondary power source. The energy capturing and storing device further comprises a photovoltaic cell, a thermionic converter, or a combination of both for converting non-electrical energy (i.e, light or heat) into electrical energy which may be stored for use in powering the lighting element when the primary source of electrical power is either unavailable or when its use is undesirable. In some situations, the source of non-electrical energy is the light bulb itself, thereby making this system essentially “self-charging”.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1A provides a somewhat simplified cross-sectional side view of an exemplary light bulb system in accordance with the present invention wherein the light bulb system includes a thermionic device for converting heat energy into electrical energy for use in powering the lighting element.

FIG. 1B provides a side view of an exemplary light bulb system in accordance with the present invention wherein the light bulb system includes a thermionic device for converting heat energy into electrical energy for use in powering the lighting element.

### DETAILED DESCRIPTION OF THE INVENTION

Exemplary embodiments of the present invention are now described with reference to the Figures. Reference numerals are used to refer to the various elements and structures. In other instances, well-known structures and devices may be shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to light bulbs, and more specifically to a light bulb system that includes self-charging bulbs that generate electricity by capturing (i) heat generated by the bulbs themselves, or (ii) from one or more light sources, including the bulb itself. Both fluorescent and incandescent light bulbs generate energy in the form of heat and light when lit. Heat and light energy may be captured and used to charge a battery that will in turn power the light bulb under certain conditions (e.g., in the absence of electric power from a primary electrical source). The present invention provides several embodiments of self-charging light bulbs that utilize this approach. As previously indicated, a first general embodiment of this invention provides a lighting system; a second general embodiment of this invention provides a light bulb system; and a third general embodiment of this invention provides a rechargeable light bulb system. With reference now to the Figures, one or more specific embodiments of this invention shall be described in greater detail.

A first exemplary embodiment of the present invention (not shown in the Figures) includes either a fluorescent, light-emitting diode (LED), or incandescent bulb having a battery back-up. The battery, which is typically inside the bulb housing, is initially charged by an external AC current while the bulb is being used in a standard light socket. When electrical power fails (such as during a power outage), the bulb may be switched to the battery so that it remains lit. This embodiment of the bulb of the present invention typically includes an external switch for turning the battery back-up system on or off. A relatively small version of this bulb utilizes an internal 3.7V lithium battery.

In a second exemplary embodiment of the present invention (not shown in the Figures), a battery included within the body of the light bulb is charged with one or more micro-solar panels or photovoltaic cells, which may be configured in an array. When the battery is fully charged, the circuit may be switched, manually or automatically, from AC to DC for using the electrical power stored in the battery. Using only the UV light captured by the solar panel means that no AC is used to charge the battery and thus the power used when the light bulb switches power modes is derived solely from captured light energy.

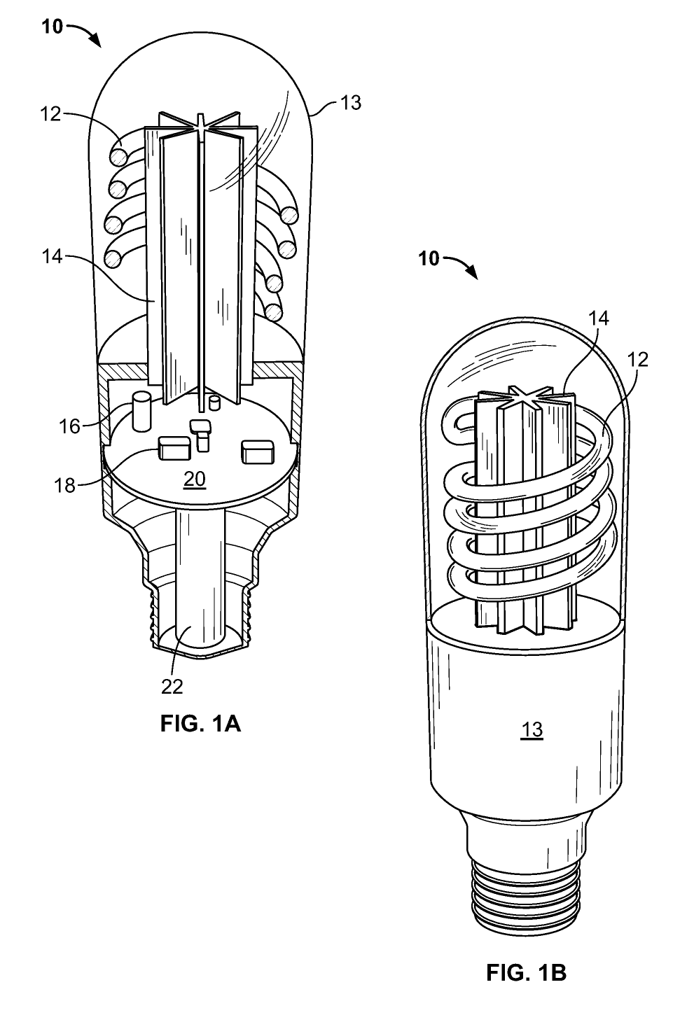

FIGS. 1A-B provide illustrative views of a third exemplary embodiment of the present invention. This embodiment is referred to as a “thermal chip bulb” and utilizes thermionic energy conversion to transform heat energy into electrical energy. This embodiment includes a fluorescent bulb or an LED with a built in battery backup system that is charged by the conversion of heat into electrical energy. As will be appreciated by those skilled in the art, microprocessor (i.e., a “chip”) is included to determine and control when the bulb operates on direct AC current and when the bulb utilizes the energy stored in the internal battery. This embodiment typically involves heat energy moving from a hot state to a cold state. A portion of the energy that would normally be dissipated into the air during this process is convertible into electrical energy. If a cooling phase is included in this embodiment, the bulb heats the chip while on and cools the chip when turned off. This cycle is typically repeated numerous times during normal use for storing energy in the battery.

With reference to FIGS. 1A-B, this exemplary embodiment of bulb 10 includes fluorescent tube 12, which is enclosed in housing 13. Plates 14 are heat energy conversion (i.e., thermionic or thermal conversion) plates. Ballast 16 and electronics 18 are mounted on a PC motherboard or other circuit board or controller 20, which sits atop storage battery 22. In one version of this embodiment, the AC current powers bulb 10 and thermionic plates 14 provide power to charge battery 22. Battery 22 functions as a backup or secondary power source when primary power is lost. Alternately, when battery 22 is fully charged, bulb 10 may be switched to battery power, thereby terminating AC power input. Thus, bulb 10 operates solely from power generated by heat loss from the normal operation of the bulb. The AC charges battery 22 also and thermionic plates 14 add a maintenance charge. The rectified power from thermonic plates 14 is added to the power to make bulb 10 more energy efficient. A storage capacitor (not shown) is used to trap power from plates 14 and return it to bulb 10. This version is a non-battery operated unit and would likely be less expensive than other versions. It would not have the battery backup function when primary power is lost. Returning even a small portion of the energy lost by heat can be a major improvement in efficiency of any type of bulb.

As will be appreciated by those skilled in the art, a typical thermionic converter consists of a hot electrode which thermionically emits electrons over a potential energy barrier to a cooler electrode, producing a useful electric power output. Cesium vapor is used to optimize the electrode work functions and provide an ion supply (by surface contact ionization or electron impact ionization in a plasma) to neutralize the electron space charge. From a physical electronic viewpoint, thermionic energy conversion is the direct production of electric power from heat by thermionic electron emission. From a thermodynamic viewpoint, it is the use of electron vapor as the working fluid in a power-producing cycle. A thermionic converter consists of a hot emitter electrode from which electrons are vaporized by thermionic emission and a colder collector electrode into which they are condensed after conduction through the interelectrode plasma. The resulting current, typically several amperes per square centimetre of emitter surface, delivers electrical power to a load at a typical potential difference of 0.5-1 volt and thermal efficiency of 5-20%, depending on the emitter temperature (1500-2000 K) and mode of operation. See, N. S. Rasor, “Thermionic energy converter”, Fundamentals Handbook of Electrical and Computer Engineering, vol. II, S. S. L. Chang., Ed., New York: Wiley, 1983, p. 668; and G. N. Hatsopoulos and E. P. Gyftopoulos, Thermionic Energy Conversion, vol. I, (1973); vol II, (1979); MIT Press, Cambridge, Mass., both of which are incorporated by reference herein, in their entirety.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A lighting system, comprising:
(a) a lighting element, wherein the lighting element is adapted to draw electrical power from a standard light bulb socket as a primary power source; and
(b) an energy capturing and storing device in electrical communication with the lighting element for providing sufficient electrical power to the lighting element as a secondary power source, wherein the energy capturing and storing device is initially charged and then recharged with successive uses of the light bulb system by the primary power source.

2) The light bulb system of claim 1, further comprising a housing for containing both the lighting element and the energy capturing element.

3) The light bulb system of claim 1, wherein the lighting element is a fluorescent lighting element.

4) The light bulb system of claim 1, wherein the lighting element is an LED lighting element.

5) The light bulb system of claim 1, wherein the energy capturing and storing device further includes at least one rechargeable battery, and wherein the at least one rechargeable battery is adapted to be initially charged and subsequently recharged by electrical power drawn from a standard light bulb socket.

6) The light bulb system of claim 1, wherein the energy capturing and storing device further includes means for capturing light energy and converting that light energy into electrical energy for use by the lighting element.

7) The light bulb system of claim 1, wherein the energy capturing and storing device further includes means for capturing heat energy and converting that heat energy into electrical energy for use by the lighting element.

8) A light bulb system, comprising:
(a) a lighting element, wherein the lighting element is adapted to draw electrical power from a standard light bulb socket as a primary power source; and
(b) an energy capturing and storing device in electrical communication with the lighting element for providing sufficient electrical power to the lighting element as a secondary power source, wherein the energy capturing and storing device further comprises means for capturing and converting non-electrical energy into electrical energy for use in powering the lighting element.

9) The light bulb system of claim 8, further comprising a housing for containing both the lighting element and the energy capturing element.

10) The light bulb system of claim 8, further comprising microprocessor means for controlling the source of electrical power used by the light bulb system.

11) The light bulb system of claim 8, wherein the lighting element is a fluorescent lighting element.

12) The light bulb system of claim 8, wherein the lighting element is an LED lighting element.

13) The light bulb system of claim 8, wherein the energy capturing and storing device further includes means for capturing light energy and converting that light energy into electrical energy for use by the lighting element.

14) The light bulb system of claim 8, wherein the energy capturing and storing device further includes means for capturing heat energy and converting that heat energy into electrical energy for use by the lighting element.

15) A rechargeable light bulb system, comprising:
(a) a lighting element, wherein the lighting element is adapted to draw electrical power from a standard light bulb socket as a primary power source; and
(b) an energy capturing and storing device in electrical communication with the lighting element for providing sufficient electrical power to the lighting element as a secondary power source, wherein the energy capturing and storing device further comprises at least one of a photovoltaic cell and a thermionic converter for capturing and converting non-electrical energy into electrical energy for use in powering the lighting element.

16) The light bulb system of claim 15, further comprising a housing for containing both the lighting element and the energy capturing element.

17) The light bulb system of claim 15, further comprising microprocessor means for controlling the source of electrical power used by the light bulb system.

18) The light bulb system of claim 15, wherein the lighting element is a fluorescent lighting element.

19) The light bulb system of claim 15, wherein the lighting element is an LED lighting element.

20) The light bulb system of claim 15, wherein the energy capturing and storing device further includes an array of photovoltaic cells.
